(19) United States
(12) Patent Application Publication
(10) Pub. No.: US 2008/0294398 A1
(43) Pub. Date: Nov. 27, 2008

(54) Method and apparatus for the automated construction of models of activities from textual descriptions of the activities

(75) Inventors: Yan Qu, Cupertino, CA (US); David A. Evans, Pittsburgh, PA (US); Ilya M. Goldin, Pittsburgh, PA (US)

Correspondence Address: JONES DAY, 222 EAST 41ST ST, NEW YORK, NY, 10017, US

(73) Assignee: JustSystems Evans Research, Inc.

(21) Appl. No.: 11/807,007

(22) Filed: May 25, 2007

(51) Int. Cl. G06F 17/00; G06F 17/20; G06K 9/62

(52) U.S. Cl. 703/6; 382/161; 382/225; 704/1

(57) ABSTRACT

A method of automatically constructing a model of an activity from an unsupervised examination of a plurality of textual documents describing the activity is comprised of: extracting prototypical steps from the plurality of textual documents; sequencing the extracted steps; aligning the sequenced steps; and constructing the model based on the aligned steps. The model may take the form of a step vs. position matrix which identifies the prototypical steps that make up the activity and provides the probability of each step occupying each position within the activity. The model thus constitutes common sense knowledge that encodes the stereotypical steps of an activity and the stereotypical sequencing of the steps.

### BACKGROUND

The present disclosure is directed generally to modeling and, more particularly, to constructing activity models (prototypes) from the automated (unsupervised) review of textual documents describing those activities.

Modeling human activities is useful for building a variety of intelligent systems, such as common-sense driven search (Liu et al. 2002) and human daily activity monitoring (Wyatt et al. 2005). A human activity can be defined as consisting of a number of possibly sequenced steps for achieving a certain goal. Being able to model activities provides the opportunity for computers to assist humans in the activity. For example, if the activity is accurately modeled, and the person performing the activity is on step 3, a computer could infer that step 4 is next and provide the materials or instrumentalities needed for step 4. Computers could be used to monitor the elderly or infirm to determine if they are performing an activity correctly. Many other possibilities are found in the literature.

Activity models have been studied from the early days of AI and common sense knowledge systems in the forms of frames and scripts (e.g., Minsky 1975; Schank and Abelson, 1977). Both models promote the use of relatively large and prototypical structures for representing activities as a type of common sense knowledge. To deal with the knowledge acquisition bottleneck, recently, researchers have gone to the Web for common sense knowledge acquisition, relying either on public input (Singh et al. 2002; Matuszek et al. 2005) or on particular genres of Web documents (Perkowitz et al. 2004; Wyatt et al. 2005).

Recent research on constructing or extracting activity models from text builds upon the assumption that there is a mapping between human activities and textual descriptions of these activities, and thus models of human activities can be constructed or extracted from text. The process of constructing or extracting is sometimes referred to as mining. In the prior art, all activities are assumed to have similar structures and their models are assumed to be amenable to similar methods of construction. Our empirical analysis of textual activity descriptions shows that descriptions of activities are not all alike; for instance, they vary in the sequencing characteristics of the steps.

### SUMMARY

The disclosed method and apparatus are directed to the automated, or unsupervised, construction of activity prototypes (i.e. models of activities comprised of a number of steps) from a plurality of textual documents. One embodiment of the method is comprised of: extracting prototypical steps from a plurality of textual documents; sequencing the extracted steps; aligning the sequenced steps; and storing the aligned steps. In an alternative embodiment, the steps may be labeled. In another embodiment, a model is built from the stored, aligned steps. The model may take the form of a step vs. position matrix. The matrix may identify the prototypical steps that make up the activity and provide the probability of each step occupying each position within the activity. The model thus constitutes common sense knowledge that encodes the stereotypical steps of an activity and the stereotypical sequencing of the steps.

According to another aspect of the present invention, an apparatus is disclosed for performing the method of the present invention.

### BRIEF DESCRIPTION OF THE DRAWINGS

For the present invention to be readily understood and easily practiced, various embodiments will now be described, for purposes of illustration and not limitation, in conjunction with the following figures, wherein:

FIG. 1 illustrates the process of constructing a model of an activity from textual documents describing the activity according to one embodiment of the present invention;

FIG. 2 illustrates a process for constructing a corpus of textual documents upon which the various embodiments of the method of the present invention may operate;

FIG. 3 illustrates one process for extracting prototype steps of an activity;

FIG. 4 illustrates alignment using MSA software of various pumpkin soup recipes;

FIG. 5 illustrates alignment using MSA software of the activity “assigning chores to kids;”

FIG. 6 illustrates F scores over different activity types;

FIG. 7 illustrates purity scores over different activity types;

FIG. 8 illustrates scores of multiple sequence alignment; and

FIG. 9 illustrates exemplary hardware on which the various embodiments of the method of the present invention may be practiced.

### DESCRIPTION

An activity consists of steps that can be described in text in a variety of ways. Some documents concentrate on the steps comprising the activity, while other documents provide more background and elaboration along with the description of the steps.

An activity prototype (model), consists of the prototypical steps of an activity and the prototypical sequencing of the steps. While variant activity descriptions may vary in content and style, the activity prototype (model) captures the commonality of the variant descriptions.

Certain definitions will now be introduced. The following definitions are not intended to be the only manner in which an activity prototype may be defined or expressed, but are provided as one embodiment of a definition and expression of the activity prototype.

An activity sequence s may consist of a sequence of k steps s: {tₗ, . . . , tₖ} in a specific order, where k is the length of s.

Multiple sequence alignment: Let T be a finite set of steps. Let the character “-” represent inserted gaps. Let sₗ, . . . , sₖ be k sequences over T with lengths nₗ, . . . , nₖ. A multiple sequence alignment of Sₗ, . . . , sₖ is a matrix k×l with the following four properties:

A[i][j[εT∪{“-”} l≦i≦k, l≦j≦l

$$•max \{ {n}_{1} , … , {n}_{k} \} \leq l \leq {\sum }_{i = 1}^{k} {n}_{i}$$

The ith row without blanks equals s,

No column consists entirely of blanks

As an illustration, a multiple sequence alignment of eight activity sequences (with the letters A through I denoting the steps sauté onion (A), add ingredients (B), heat/boil (C), simmer (D), blend/puree (E), add cream (F), heat (G), season (H), serve (I)) for the activity “making pumpkin soup” may be represented as follows:

| | c1 | c2 | c3 | c4 | c5 | c6 | c7 | c8 |
|---|---|---|---|---|---|---|---|---|
| s1 | — | — | C | D | — | F | — | I |
| s2 | A | B | C | — | — | F | — | I |
| s3 | A | — | C | D | E | G | — | I |
| s4 | A | B | C | D | E | F | H | I |
| s5 | A | B | — | D | E | F | H | G |
| s6 | A | B | — | D | E | — | — | I |
| s7 | A | — | — | E | E | — | — | G |
| s8 | A | — | — | D | E | H | G | I |

Activity Prototype (P): Let T be a finite set of m steps T: {tₗ, . . . , tₘ} including the character “-” representing inserted gaps. Let A be a multiple sequence alignment of length l over k sequences, e.g., l is the number of positions in the global alignment and k is the number of documents (sequences). The prototype P of A is a matrix of dimension m×l with the following properties:

$$a [ i ] [ j ] = p ( {t}_{i} at position {c}_{j} ) = \frac{count ( {t}_{i} , {c}_{j} )}{{\sum }_{n = 1}^{m} count ( {t}_{n} , {c}_{j} )} \qquad Formula ( 1 )$$

For the examples shown above, the prototype for “making pumpkin soup” is as follows:

| s | c1 | c2 | c3 | c4 | c5 | c6 | c7 | c8 |
|---|---|---|---|---|---|---|---|---|
| — | 0.125 | 0.5 | 0.5 | 0.125 | 0.25 | 0.25 | 0.625 | |
| A | 0.875 | | | | | | | |
| B | | 0.5 | | | | | | |
| C | | | 0.5 | | | | | |
| D | | | | 0.875 | | | | |
| E | | | | | 0.75 | | | |
| F | | | | | | 0.5 | | |
| G | | | | | | 0.125 | 0.125 | 0.25 |
| H | | | | | | 0.125 | 0.25 | |
| I | | | | | | | | 0.75 |
| total | 1 | 1 | 1 | 1 | 1 | 1 | 1 | 1 |

This definition of an activity prototype is based on a multiple sequence alignment of the activity sequences, where each cell in the matrix represents the probability of observing a certain step at a particular location in the global alignment. An ideal profile has one cell with probability 1.0 in each column, while a perfectly useless profile has all cells of equal probabilities.

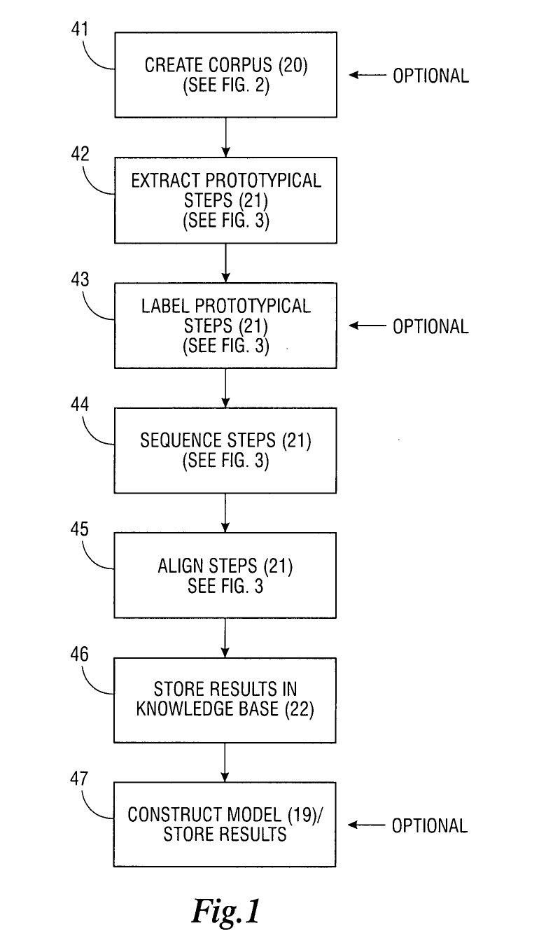

Given an activity, the process of constructing its prototype 19 from a corpus of textual documents 20 involves several steps as shown in FIG. 1: creating 41 the corpus 20 (which is optional); extracting 42 prototypical steps 21 from the corpus of documents 20; labeling 43 the prototypical steps 21 (which is optional); sequencing 44 the prototypical steps 21; and aligning 45 the sequenced prototypical steps 21. The aligned prototypical steps 21 may be stored 46 in a knowledge base 22. The knowledge base 22 may be stored in a computer readable medium. Finally, the prototype (model) 19 may be constructed 47 from the information in the knowledge base 22. The model 19 may also be stored in a computer readable medium. The process shown in FIG. 1 of constructing the prototype may alternately be referred to in the literature as “discovering”, “extracting”, or “mining.”

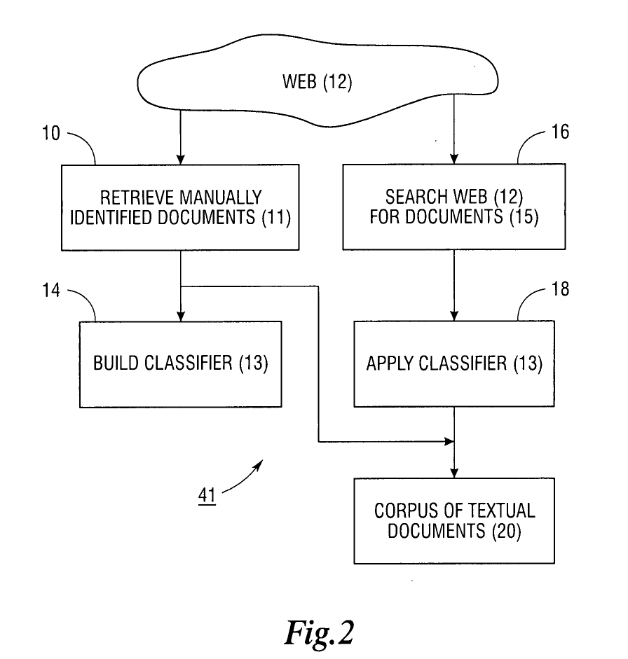

FIG. 2 illustrates the process 41 for creating a corpus of textual documents 20 upon which the apparatus and methods of the present invention may operate. The process of FIG. 2 is provided to illustrate a method of obtaining a plurality of documents for mining, and is not intended to limit the disclosed methods and apparatus for constructing activity models from the automated review of textual documents describing those activities.

FIG. 2 illustrates the retrieval 10 of manually identified documents 11 from the web 12. The manually identified documents 11 should have accurate descriptions of the activity that is to be modeled. An example would be “how to” documents that describe, step by step, how to accomplish some activity. After a sufficient sample of such documents has been retrieved, a classifier 13 is constructed at step 14. The classifier 13 is a type of filter that can be used to determine if other documents are sufficiently similar to the “how to’ documents used to build the classifier 13.

After the classifier 13 is built, the web 12 is searched at 16 to retrieve a large number of documents 15. The documents 15 are reviewed at step 18 by the classifier 13, and those documents that are determined to be relevant are added to the corpus of textual documents 20. The manually retrieved documents 11 from step 10 can also be added to the corpus 20.

As is known, text descriptions of the same activity can vary in style and in content. Some texts are more concise, while others include more background and elaboration. We anticipate that a candidate prototypical step of an activity should be a step that is distributed/described in many different documents and is a step that is represented in different documents by semantically similar text units.

Returning to FIG. 1, for the step of extracting prototype steps 42, the goal is to extract steps that are described in semantically similar text units and that appear in different descriptions of the same activity. We use clustering to extract common groups of steps with the aim that a cluster should cover as many descriptions of the same activity step as possible. Briefly, the procedure is to partition each document into candidate steps, cluster the candidate steps into semantically or otherwise related groups, and select those clusters that cover many documents.

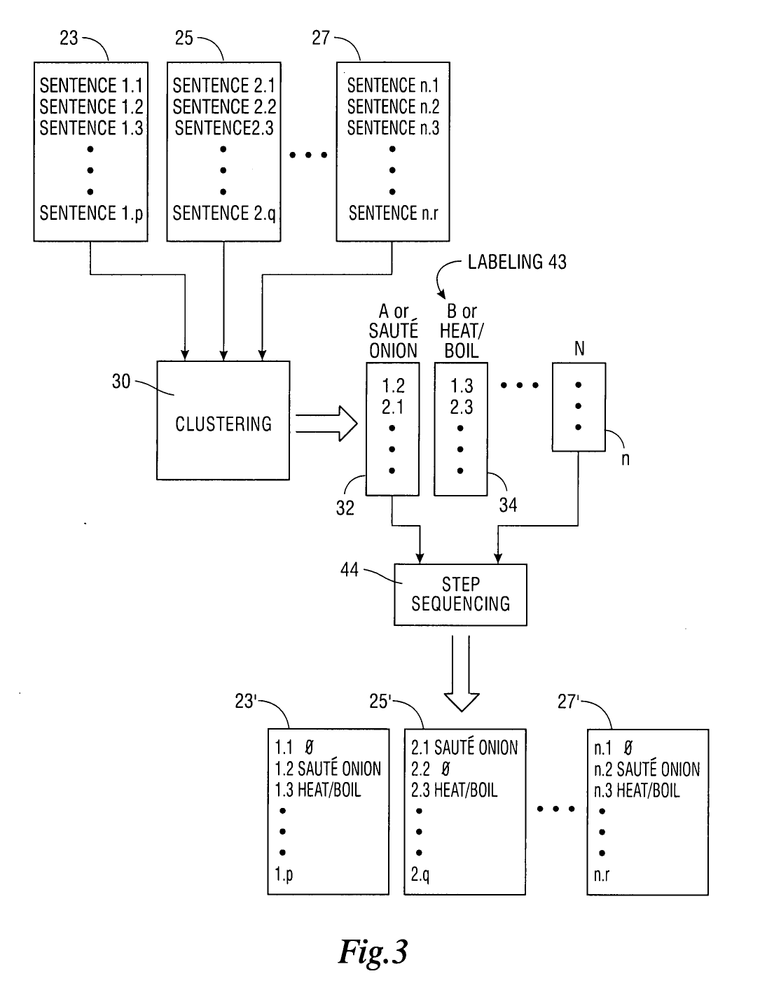

The foregoing procedure is illustrated in FIG. 3. While step granularity is variable, we may take a single sentence as the unit for representing a candidate step. Clearly, other units, including a single word, may be used to represent a candidate step. In FIG. 3, three documents 23, 25, 27 have been partitioned into candidate steps labeled 1.1, 1.2 through 1.p for document 23, candidate steps 2.1, 2.2 through 2.q for document 25, and candidate steps n.1, n.2 through n.r for document 27.

Once the documents are partitioned into candidate steps, we use at step 30 in FIG. 3, for example, Hierarchical Agglomerative Clustering to extract step clusters 32, 34, through n (Salton 1988) and measure similarity between sentences (candidate steps) with, for example, the Dice coefficient (van Rijsbergen 1979):

$$s = \frac{2 \vert X ⋂ Y \vert}{\vert X \vert + \vert Y \vert}$$

where X and Y represent the set of key words in two sentences. Clustering can be based on complete link, single link, or average link. A similarity threshold can be used for stopping linking of clusters with similarity scores below the threshold. A variety of features can be used as term features for clustering, such as simplex NPs, included sub-terms, verbs, and adjectives (excluding stopwords).

It is desirable for sentences to cluster together based on word overlap that is due to genuine semantic relatedness. Noise can be caused, however, by word overlap from spurious, idiosyncratic word choice of individual authors. We introduce two measures to nominate clusters as candidate prototype steps.

The first measure is Diversity (d) which captures the number of documents that are covered by the cluster. A prototype step needs to cover more than d documents (e.g., d>3).

The second measure is ClusterSize (g, h): A prototype step should have between g and h items in the cluster, discarding clusters that are too small or too big. Values for g and h are a function of the number of documents and the average number of sentences per step.

The following table illustrates a segment of auto-extracted prototype steps with d>2, g>2 and h=∞ for the “making pumpkin soup” activity.

TABLE 1
...<cluster>
<diversity>3</diversity>
<count>6</count>
<label>add;milk</label>
<sentences>
doc1s24 Add 1 1 2 c broth and process until smooth
doc1s26 Add the rest of the broth and process again
doc3s4 Add milk and cook another 5 minutes
doc4s8 Add milk in the same manner
doc4s7 Add half and half in a thin stream stirring while adding
</sentences>
</cluster>
<cluster>
<diversity>5</diversity>
<count>6</count>
<label>serve</label>
<sentences>
doc1s33 Serve
doc8s4 To serve pour into a tureen and add the cream
doc5s6 Serve with a dollop of whipped cream and sprinkle with paprika
doc6s6 Serve with sour cream 1 dollop on each serving
doc7s5 Garnish with parsley and serve from a hollowed out pumpkin
which as been warmed for 20 minutes in 350 degree oven
doc7s6 My mother Marge Beckler serves this soup each Thanksgiving
in tiny hollowed pumpkins for each grandchild
</sentences>
</cluster>...

Optionally, the clusters 32, 34 through n can be labeled for ease of interpretation. We used a “most frequent words” label, but many alternative techniques are available (e.g., Treeratpituk & Callan 2006). For example, in FIG. 3, the first cluster 32 is labeled “sauté onion.” Each sentence in the step cluster is given that label, which is reflected in the representation of documents 23′, 25′, and 27′. The cluster 34 is labeled “heat/boil.” Each sentence within step cluster 34 takes that label. Alternatively, we can simply map the clusters into letters for better visualization of alignment. For example, cluster 32 could be “A”, cluster 34 could be “B”, and cluster n could be assigned “N.”

In general, accurate sequencing 44 of activity steps 21 can require complex temporal reasoning about time points and intervals, such as when activities are described in a narrative style. Because we restrict the genre to “how-to” texts, we simplify by equating the order of the steps in the text to their sequence.

TABLE 2

```
For each document d
  Seq_{d}←{ } # Begin with an empty sequence
    For each sentence s
      If s appears in cluster cᵢ
        Push label(cᵢ), Seq_{d}
  Return Seq_{d}
```

In the procedure illustrated in Table 2, we represent each document with a sequence of cluster labels that is ordered by the appearance of the clusters' constituent sentences in the original document text. For example, in FIG. 3, after cluster 32 is labeled “sauté onion” and cluster 34 is labeled “heat/boil”, etc., the labels are used in representing the documents 23, 25, and 27 as a sequence of cluster labels 23′, 25′, and 27′, respectively.

For the alignment step (see step 45, FIG. 1), we use the Multiple Sequence Alignment (MSA) technique, commonly used in bioinformatics for computing common sequences, detecting similarities and differences in sequences, etc. MSA has recently been applied to natural language processing tasks (Barzilay & Lee 2002; Lacatusu et al. 2004). The step sequences of 44 in FIG. 1 are used as the input to the MSA software.

We use, for example, the T-COFFEE MSA software to compute alignment scores and visualize the prototype steps. The reader is referred to Notredame et al. (2000) for details of alignment computation.

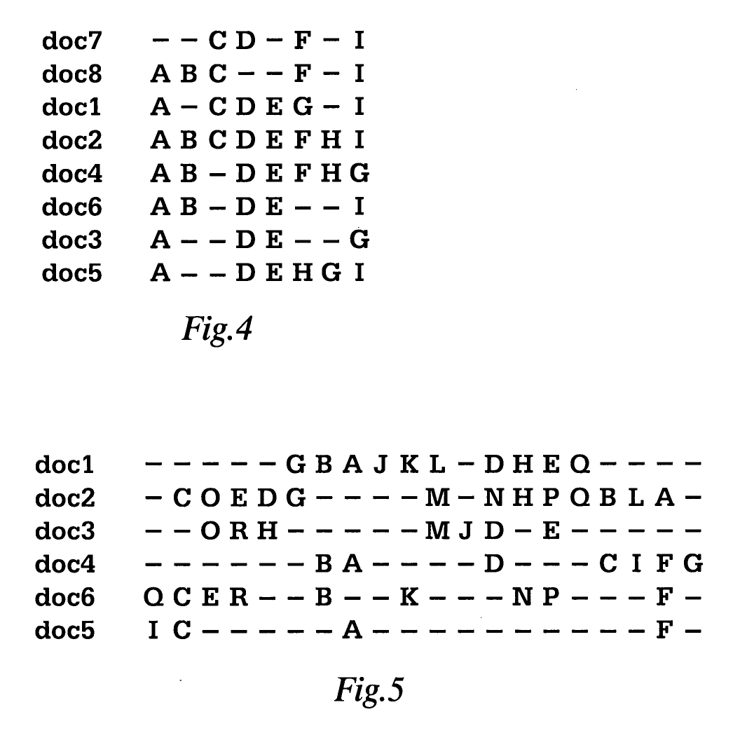

In FIGS. 4 and 5, we show alignments of two activities where the activity steps were mapped to an alphabet for ease of visualization. Again, the mapping for FIG. 4 is as follows: sauté onion (A), add ingredients (B), heat/boil (C), simmer (D), blend/puree (E), add cream (F), heat (G), season (H), serve (I). Strong alignments can be shown by the vertical columns formed by certain of the letters. This activity, making pumpkin soup, is comprised of steps which generally align well, with a strong global alignment (alignment score 68; Notredame & Abergel 2003). FIG. 5 shows the alignment of the steps in the activity “assigning chores to kids.” The mapping between the steps and the letter representations is not significant. What is significant, is that for this activity, the steps do not align well globally (alignment score 43).

After the steps are aligned at 45 (FIG. 1), the results are stored in the knowledge base 22 at step 46. The activity model 19 can be constructed from the knowledge base 22 as shown by 47 in FIG. 1 by using formula (I) above. An example of a prototype 19 is illustrated above following formula (I). As mentioned previously, in this prototype, each cell in the matrix represents the probability of observing a certain step at a particular location in the global alignment.

Prototypes or models may be categorized into four types or topologies depending upon whether all steps are required and whether steps need to be critically ordered, as shown below:

| | All steps | Steps critically |
|---|---|---|
| | required | ordered |
| Sequential instructions (SI) | Yes | Yes |
| Non-sequential instructions (NI) | Yes | No |
| Escalating instructions (EI) | No | Yes |
| Non-sequential suggestions (NS) | No | No |

Sequential instructions comprise a series of steps that must be performed in order. An example is a standard recipe, like this one for pumpkin soup:
Sauté lightly onion and bacon in large pot. Add pumpkin, water, apple cider, brown sugar, chicken bouillon, apple, liquid smoke salt, white pepper, and crystallized ginger to the pot. Cover and simmer for 1 hour. Stir frequently. Blend to thicken in blender-size batches. Serve with sour cream (1 dollop on each serving).

Order is critical, and all steps are important for activity completion.

Non-sequential instructions consist of steps that must all be performed, but whose order is unimportant. An example is this set of instructions for performing 50,000-mile maintenance on a car:

1. Perform a general tune-up—check the plugs, plug wires, belts, coolant, filters and timing.

2. Change the oil and oil filter.

3. Check the tires for wear. Replace as necessary.

4. Inspect the brakes. Service as necessary.

5. Change windshield wiper blades.

6. Touch up any scratched paint or minor body damage

7. Check for rust.

While every step is necessary, the steps can be performed in any order. There is no logical reason that the oil must be changed before the tires or brakes are inspected.

Escalating instructions involve steps that should be followed in order, but only until success. For example, here are some instructions for shutting off a car alarm (abbreviated to save space):
1. Check for user error. Consult the owner's manual for directions on how to turn the car alarm on and off.
2. Put the key in the ignition and try to start the car.
3. Find the alarm's fuse.
4. Locate the fuse that has the alarm label.
5. Pull the alarm fuse with the fuse puller (sometimes found in the fuse box) or a pair of needle-nose pliers.

6. As a last resort, disconnecting the battery's negative terminal will stop the alarm, but it will also keep your car from starting.

While Steps 3 through 5 here are sequential, Step 1, Step 2, the sequence of Steps 3-5, and Step 6 constitute alternatives. Try Step 1 first (Step 1 here is actually a preventive step—this is something you should do before the situation arises). If Step 1 is successful, there is no need to try any additional steps; but if it is unsuccessful, you should try Step 2. If Step 2 is successful, there is no need to go on; if it is unsuccessful, you should try the sequence of Steps 3 through 5. If that is successful, there is no need to go on; if unsuccessful, you should try Step 6. The steps are usually ordered from the easiest/safest alternative to the most difficult/risky.

Non-sequential suggestions need not be performed in order, nor is it necessary to complete all of the steps. A person can pick and choose whichever “steps” seem easiest or most promising. For example, here are “instructions” for teaching a child to clean his or her room:
1. Establish a firm room-cleaning schedule for your child, such as cleaning at the end of each day before bed.
2. Put him or her in charge of putting away toys after playing with them.
3. Try to make cleaning fun—play music from his or her favorite movie or band while sorting toys, for example.
4. Put up a bulletin board on which your child can keep and display his or her art and other creations.
5. Show your child that his or her desk is for writing and drawing, as well as for keeping papers, books, and writing utensils.
6. Go through your toys possessions together once a year, pick out games and toys that he or she no longer uses and donate them to charity.
7. Provide separate storage and play areas within a room if two or more children share it.

A parent might be successful in this endeavor using only steps 2 and 3. If the parent is successful, there is no need to follow the remaining steps.

A given set of instructions may not fall neatly into a single category. Sequential or non-sequential instructions may have optional steps, often towards the end. Some lists may appear to be escalating instructions for some sub-sequences but non-sequential suggestions for others; also, a reader may reorder escalating instructions if he or she disagrees with the writer's assessment of which steps are more difficult and risky. This knowledge of topologies is not required for practicing the method set forth in FIG. 1, although a knowledge of topology a priori may be of some advantage when performing the sequencing step 44 of FIG. 1

We manually constructed prototypes of 8 activities as Gold Standard (GS) prototypes from the text descriptions of activities—2 different activities for each type based on the typology described above. For a given activity, first, we collected 4-8 different “how-to” Web pages. Then the Web pages were manually aligned with labels denoting activity steps that represented similar prototypical actions (e.g., sautéing ingredients) across the multiple descriptions. Then, we filtered out all steps that did not occur in at least two descriptions of the activity. Finally, we discarded background, clarification, or elaboration sentences, leaving only the central sentences in each step. The GS prototype of an activity thus consists of a set of clusters representing activity steps, each of which consists of sentences from different documents representing the step. The following discussion and the evaluation results reported below are based on the 8 activities with a GS.

Table 3 provides the statistics of the corpus and the GS prototypes. On average, a transformation from general text descriptions of an activity to its prototype involves 73.9% reduction in content. This reduction rate is comparable to existing multi-document summarization work (Goldstein et al. 1999).

TABLE 3
Characteristics of corpus and GS

| | Avg. sent | Proto.steps | % |
|---|---|---|---|
| | per doc | per activity | reduction |
| SI | 44 | 13.5 | 69.4% |
| NI | 51 | 14.5 | 71.8% |
| EI | 43 | 9.5 | 78.1% |
| NS | 41 | 14 | 65.5% |
| total | 49 | 12.9 | 73.9% |

Our analysis shows that although most activity steps are described in text by more than one sentence, the steps can be sufficiently represented or summarized by single sentences; most other sentences only provide background, elaboration, and clarification. In the manually prepared Gold Standards, more than 75% of the steps are represented by single sentences from texts.

We evaluate the clustering results against the manual classification of the activity steps in the GS. The first measure is the F-measure. Suppose there are k classes in GS. Suppose there are m clusters extracted by the system, nᵢ is the number of sentences of a particular class Lᵢ, nᵣ is the number of sentences of a particular cluster Sᵣ. Suppose nⁱᵣ is the number of sentences of gold standard class Lᵢ in Sᵣ. Then the F score of this class and cluster is defined to be:

$$F ( {L}_{i} , {S}_{r} ) = \frac{2 \times P ( {L}_{i} , {S}_{r} ) \times R ( {L}_{i} , {S}_{r} )}{P ( {L}_{i} , {S}_{r} ) + R ( {L}_{i} , {S}_{r} )}$$

where R(Lᵢ, Sᵣ) is the recall value defined as nⁱᵣ/nᵢ and P(Lᵢ, Sᵣ) is the precision value defined as nⁱᵣ/nᵣ for the cluster Sᵣ against the class Lᵢ. The F score of the cluster Sᵣ is the maximum F score value attained against all classes:

$$F ( {S}_{r} ) = {max}_{i = 1 , k} F ( {L}_{i} , {S}_{r} )$$

The F score of the entire clustering solution is the sum of the individual cluster F scores weighted according to the cluster size (n is the total number of sentences):

$$F = {\sum }_{i} \frac{{n}_{r}}{n} F ( {S}_{r} )$$

To evaluate whether semantically similar sentences are grouped into clusters, we use the purity metric, often used in evaluations of clustering:

$$P ( {S}_{r} ) = \frac{1}{{n}_{r}} {max}_{i} ( {n}_{r}^{i} )$$

$$Purity = {\sum }_{r = 1}^{m} \frac{{n}_{r}}{n} P ( {S}_{r} )$$

Intuitively, a cluster whose items come from few GS classes will have higher purity than a cluster that mixes many GS classes.

We evaluated our procedure over the activity corpus described above. We compared four runs for clustering: All-GS and NP-GS (using all features Simplex NP+Verb+Adj and only Simplex NP features respectively over sentences from GS); All-Sys and NP-Sys (using all features and NP features respectively over all sentences from corpus). The cluster size was set to between g>2 and h=∞. As it was not clear from the experiments what the optimal diversity was, the results were based on the averages from diversity d ranging from l to the number of the total number of documents of an activity.

For alignment, the Manual baselines were computed according to the human labeled step sequences. All other alignments were computed based on sequences built upon their respective step clusters.

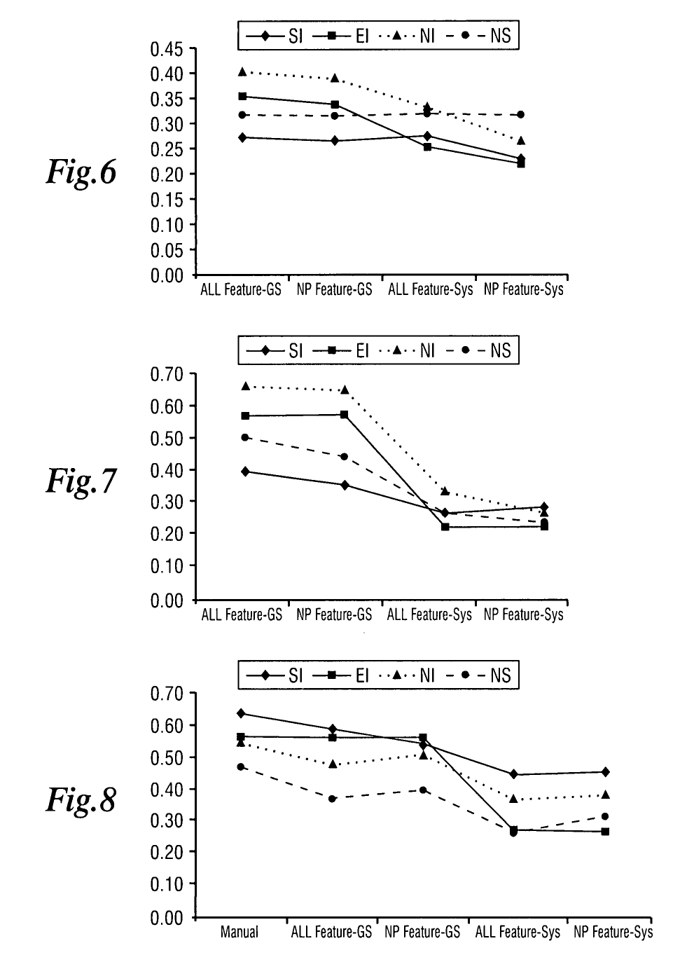

When clustering is applied to the GS sentences for automatically grouping them into activity steps, we have observed that purity and F scores are ordered in the sequence NI>EI>NS>SI (FIGS. 6 and 7). A further analysis of the corpus shows characteristics of the different types potentially make some types harder than the others. As an illustration, the following is an excerpt from a “change oil” description (SI) with the extracted terms (NPs) annotated (for similarity comparisons, the system considers not only the whole phrase, but also sub-phrases and combined terms):

Find the oil drain plug [oil drain plug]

Place the drain pan underneath the plug [drain pan, plug]

Using your wrench unscrew the drain plug [wrench, drain plug]

Screw the plug back in [plug]

Contrast this with an excerpt from a “winterizing car” description (NI):

Check antifreeze mixture [antifreeze mixture]

Carry an emergency kit inside the car [emergency kit, car]

Inspect the wipers and wiper fluid [wipers, wiper fluid]

Check the battery [battery]

Change the engine oil and adjust the viscosity grade [engine oil, viscosity grade]

As we can see, SI type instructions impose strong sequencing constraints and semantic coherence constraints; thus the semantic distances between subsequent steps are small and harder for clustering to separate. In contrast, in NI and EI type instructions, the steps are generally quite independent, thus the semantic distances between the steps are quite large and easy for separation via clustering.

Turning to FIGS. 6 and 7, when clustering is applied to all sentences in the corpus, there is significant degradation in both F and purity (α=0.046 and α=0.001 respectively). This shows that to use clustering for discarding noise sentences from the desired clusters, measures other than similarity should be explored for separating noise sentences from activity central sentences.

As mentioned earlier, we compute MSA using default T-COFFEE settings. T-COFFEE computes an alignment metric (Notredame & Abergel 2003) that can be used to assess the quality of MSA. First, with the alignment metric, we can see that some types of activities generally align better than others; MSA over the gold standard produces higher alignment scores for sequential and escalating instructions than for non-sequential instructions and suggestions: SI>EI>NI>NS. It is not surprising that the latter two activities, where the order of steps is not critical, align less well. When clustering is used for extracting steps automatically, it is as expected that the alignment scores suffer as noise is introduced into the step clusters. Also observe that, with automated clustering, the alignment scores decrease significantly with the complete corpus (All-Sys, NP-Sys) compared with those with the GS corpus (All-GS, NP-GS) respectively (α<0.001 for both). This suggests that improving clustering is the first imperative step in achieving better step alignment.

TABLE 4
MSA scores for GS and system results

| | Manual | All-GS | NP-GS | All-Sys | NP-Sys |
|---|---|---|---|---|---|
| SI | 63.0 | 58.3 | 53.2 | 44.1 | 45.0 |
| EI | 55.9 | 55.7 | 55.4 | 26.4 | 26.1 |
| NI | 54.0 | 47.2 | 50.1 | 36.3 | 37.8 |
| NS | 46.5 | 36.5 | 39.5 | 25.8 | 31.0 |
| total | 54.9 | 49.4 | 49.6 | 33.2 | 35.0 |

See FIG. 8 which illustrates the scores of multiple sequence alignment

In evaluating both clustering and alignment, we have compared using two types of features: All (including simplex NP, verbs, adjectives) and NP (simplex NPs only). With the F, purity, and alignment scores, there are overall no significant differences statistically between the two types of features. This validates empirically the observation by Perkowitz et al. (2004) that activity steps can be effectively modeled based on the set of objects involved at the respective steps.

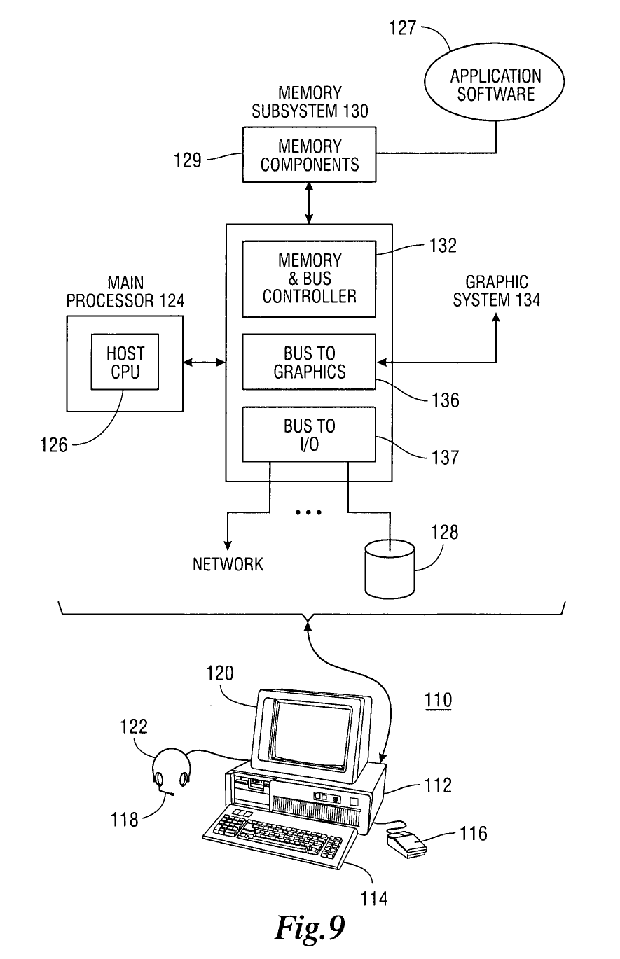

FIG. 9 is a block diagram of hardware 110 which may be used to implement the various embodiments of the method of the present invention. The hardware 110 may be a personal computer system comprised of a computer 112 having as input devices keyboard 114, mouse 116, and microphone 118. Output devices such as a monitor 120 and speakers 122 may also be provided. The reader will recognize that other types of input and output devices may be provided and that the present invention is not limited by the particular hardware configuration.

Residing within computer 112 is a main processor 124 which is comprised of a host central processing unit 126 (CPU). Software applications 127, such as the method of the present invention, may be loaded from, for example, disk 128 (or other device), into main memory 129 from which the software application 127 may be run on the host CPU 126. The main processor 124 operates in conjunction with a memory subsystem 130. The memory subsystem 130 is comprised of the main memory 129, which may be comprised of a number of memory components, and a memory and bus controller 132 which operates to control access to the main memory 129. The main memory 129 and controller 132 may be in communication with a graphics system 134 through a bus 136. Other buses may exist, such as a PCI bus 137, which interfaces to I/O devices or storage devices, such as disk 128 or a CDROM, or to provide network access.

While the present invention has been described in conjunction with preferred embodiments thereof, those of ordinary skill in the art will recognize that many modifications and variations are possible. For example, the present invention may be implemented in connection with a variety of different hardware configurations. Various extraction, sequencing, labeling, and alignment techniques, among others, may be used and still fall within the scope of the present invention. Such modifications and variations fall within the scope of the present invention which is limited only by the following claims.

What is claimed is:

1. A method of operating on a plurality of textual documents discussing an activity, comprising:
extracting prototypical steps of an activity from said plurality of textual documents;
sequencing the extracted steps;
aligning the sequenced steps; and
storing the aligned steps.

2. The method of claim 1 wherein said extracting comprises:
partitioning each of a plurality of textual documents into candidate prototypical steps;
clustering said candidate prototypical steps; and
selecting clusters that cover more than one document.

3. The method of claim 3 wherein said candidate prototypical steps are selected from the group consisting of words, phrases, sentences, or other semantic units.

4. The method of claim 2 additionally comprising labeling said steps within each of said selected clusters.

5. The method of claim 4 wherein said labeling comprises labeling said steps within each of said selected clusters with either a label containing the most frequently used words in each of said selected clusters or an arbitrary label.

6. The method of claim 1 additionally comprising collecting a plurality of textual documents.

7. The method of claim 6 wherein said collecting comprises:
retrieving a first plurality of documents;
building a classifier from said retrieved documents;
retrieving a second plurality of documents;
applying said classifier to said second plurality of documents; and
adding certain of said second plurality of documents to a corpus of textual documents based on said applying.

8. The method of claim 1 additionally comprising constructing a model of the activity based on said stored, aligned steps.

9. The method of claim 8 wherein said constructing a model comprises constructing a step vs. position matrix where each cell in the matrix represents a probability of observing a certain step at a particular location.

10. A method of constructing a model of an activity by operating on a plurality of textual documents discussing the activity, comprising:
extracting prototypical steps of the activity from said plurality of textual documents;
sequencing the extracted steps;
aligning the sequenced steps so as to define a global step alignment;
constructing a model based on said aligned steps; and
saving said model.

11. The method of claim 10 wherein said model is a step vs. position matrix where each cell in the matrix represents a probability of observing a certain step at a particular location in the global alignment of steps.

12. The method of claim 10 wherein said extracting comprises:
partitioning each of a plurality of textual documents into candidate prototypical steps;
clustering said candidate prototypical steps; and
selecting clusters that cover more than one document and that are of a predetermined size.

13. The method of claim 12 wherein said candidate prototypical steps are selected from the group consisting of words, phrases, sentences, or other semantic units.

14. The method of claim 12 additionally comprising labeling said steps within each of said selected clusters.

15. The method of claim 14 wherein said labeling comprises labeling said steps within each of said selected clusters with either a label containing the most frequently used words in each of said selected clusters or an arbitrary label.

16. The method of claim 10 additionally comprising collecting a plurality of textual documents.

17. The method of claim 16 wherein said collecting comprises:
retrieving a first plurality of documents;
building a classifier from said retrieved documents;
retrieving a second plurality of documents;
applying said classifier to said second plurality of documents; and
adding certain of said second plurality of documents to a corpus of textual documents based on said applying.

18. A computer readable medium carrying a model of an activity wherein said model comprises data identifying each step in an activity and a plurality of probabilities for each step representing the likelihoods of that step occupying locations in the global alignment of steps.

19. A computer readable medium carrying a set of instructions which, when executed, perform a method of operating on a plurality of textual documents discussing an activity, comprising:
extracting prototypical steps of an activity from said plurality of textual documents;
sequencing the extracted steps;
aligning the sequenced steps; and
storing the aligned steps.

20. A computer readable medium carrying a set of instructions which, when executed, perform a method of constructing a model of an activity by operating on a plurality of textual documents discussing the activity, comprising:
extracting prototypical steps of the activity from said plurality of textual documents;
sequencing the extracted steps;
aligning the sequenced steps so as to define a global step alignment;
constructing a model based on said aligned steps; and
saving said model.
